(19) United States
(12) Patent Application Publication
(10) Pub. No.: US 2015/0072707 A1
(43) Pub. Date: Mar. 12, 2015

(54) MOBILE SYSTEM AND METHOD FOR MARKING LOCATION

(71) Applicant: QOROS AUTOMOTIVE CO., LTD., Chanshu, Jiangsu (CN)

(72) Inventors: Eric HC Pang, Changshu (CN); Stefano Villanti, Changshu (CN)

(21) Appl. No.: 14/385,499

(22) PCT Filed: Mar. 16, 2012
(86) PCT No.: PCT/CN2012/072468

§ 371 Date: Sep. 15, 2014

(51) Int. Cl. H04W 4/02

(52) U.S. Cl. CPC H04W 4/02
USPC 455/456.1

(57) ABSTRACT

A system and method enable a user to pin a location in a mobile positioning system and transmit the location to a server for later access. The system and method also can recognize features of the location to determine a name and/or address of the location.

### FIELD OF THE INVENTION

At least one embodiment pertains to navigation, and more particularly, to a mobile system and method for marking a current location on a map.

### BACKGROUND

Conventional navigations systems enable selecting locations on a digital map. However, conventional systems do not provide a technique for marking a location and adding the marked location to a point of interest (POI) database. Accordingly, a new system and method may be needed to mark locations on a digital map with a choice of additional input methods.

### SUMMARY

Embodiments provide a mobile system, method, and software/processor that perform the method to pin the location of a mobile device or vehicle with, in an embodiment, a single touch. The location can then be transmitted to a remote device for later access and adding additional information by a user.

In an embodiment, the system comprises a position logic to determine a position of mobile system (e.g., in a vehicle or on a person); user interface logic to display a position determined by the position logic, retrieve data including a name associated with the position, and enable a user to mark the determined position; and transmission logic, operable when the user marks the determined position, to transmit the determined position and the retrieved data to a remote device. In an embodiment, the system further comprises recognition logic to acquire an image corresponding with the determined position and match the acquired image against images with associated names in a database.

In an embodiment, the method comprises: determining, with position logic, a position of a mobile system housing the position logic (e.g., in a vehicle or on a person); displaying, with a user interface logic, a position determined by the position logic and retrieve data including a name associated with the position; enabling, with the user interface logic, a user to mark the determined position; and transmitting, with a transmission logic, the determined position and the retrieved data to a remote device when the user marks the determined location. In an embodiment, the method further comprises acquiring, with recognition logic, an image corresponding with the determined position and match the acquired image against images with associated names in a database.

### BRIEF DESCRIPTION OF THE DRAWINGS

One or more embodiments are illustrated by way of example and not limitation in the figures of the accompanying drawings, in which like references indicate similar elements.

FIG. 1 is a diagram illustrating a network according to an embodiment.

FIG. 2 is a high-level extent diagram showing an example of architecture of a client, server and/or mobile system of FIG. 1.

FIG. 3 is a block diagram showing contents of the mobile system of FIG. 1.

FIG. 4 is an illustration of a user interface of the mobile system.

FIG. 5 is a flowchart illustrating a navigation marking technique.

### DETAILED DESCRIPTION

References in this description to “an embodiment”, “one embodiment”, or the like, mean that the particular feature, function, structure or characteristic being described is included in at least one embodiment. Occurrences of such phrases in this specification do not necessarily all refer to the same embodiment. On the other hand, such references are not necessarily mutually exclusive either.

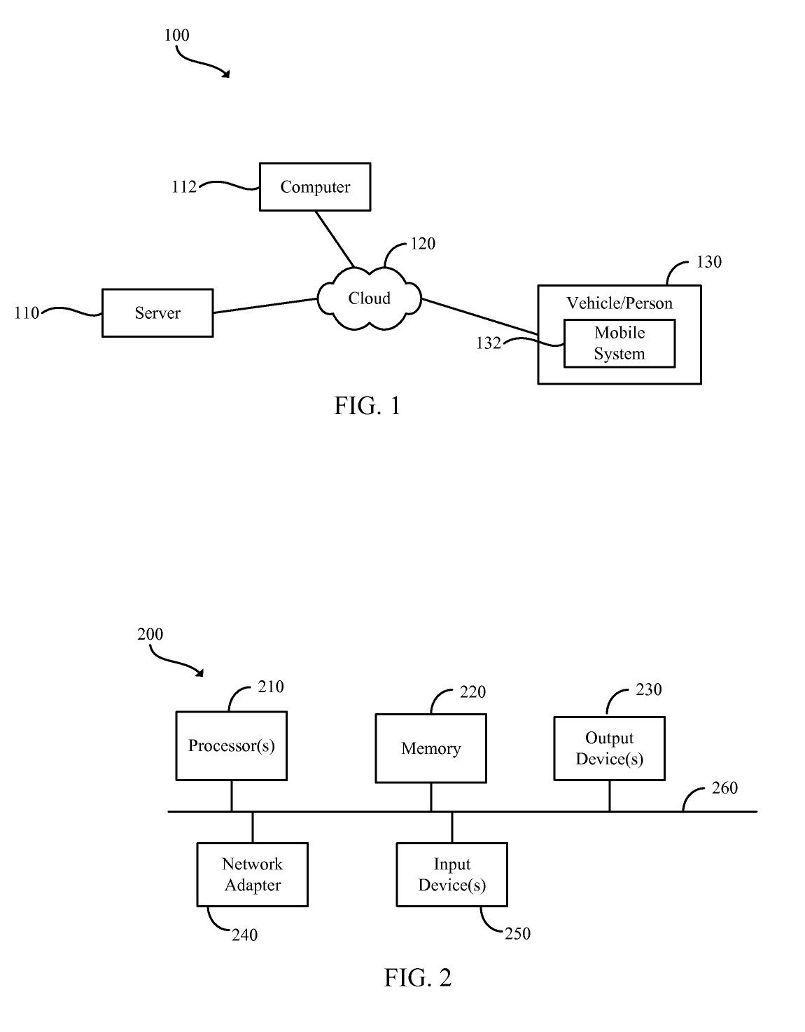

FIG. 1 is a diagram illustrating a network 100 according to an embodiment of the invention. The network 100 includes a server 110, a computer 112, a network (cloud) 120 and a vehicle (e.g., automobile) or person (referred to hereinafter as vehicle for simplicity) 130. The vehicle 130 includes a mobile system 132 that is coupled the vehicle 130 (e.g., installed in or detachably coupled to the vehicle 130 or carried by a person 130). The mobile system 132 can include mobile phones, portable navigation devices, etc. In other embodiments, the vehicle 130 can include other vehicles, such as aircraft, ships, motorcycles, submersibles, etc. Note that the network 100 can include other and/or additional nodes.

The cloud 120 can be, for example, a local area network (LAN), wide area network (WAN), metropolitan area network (MAN), global area network such as the Internet, a Fibre Channel fabric, or any combination of such interconnects. Each of the server 110, the computer 112, and the mobile system 132 may be, for example, a conventional personal computer (PC), server-class computer, workstation, handheld computing/communication device, or the like.

During operation of the network 100, a mobile device user uses the mobile system 132 to mark (“pin”) a current location using geographical coordinates or some other system, and transmits this location to the server 110. Other information can be pulled from the cloud 120, can be inputted by the user at a later time, and/or pulled or entered from/via the computer 112 via the cloud 120. If a connection to the cloud 120 is unavailable, the mobile system 132 can transmit the data when a connection becomes available. In an embodiment in which the mobile system 132 is detachable, the mobile system 132 can transmit the data wired or wirelessly to the server 110 and/or computer 112. A user, e.g., at computer 112, can then retrieve the data from the server 110. Operation of the mobile system 132 will be discussed in further detail below in conjunction with FIGS. 3-5.

In another embodiment, additional data related to the current location can also be stored to the memory and/or transmitted to the server 110, such as name and address of location. This additional data can be determined by looking to a database locally or in the cloud 120 to find a name/address corresponding to a map location and/or use image recognition technologies to match building/landscape images of the current location to a database of known images.

FIG. 2 is a high-level extent diagram showing an example of an architecture 200 of the server 110, the computer 112, or the mobile system 132 of FIG. 1. The architecture 200 includes one or more processors 210 and memory 220 coupled to an interconnect 260. The interconnect 260 shown in FIG. 2 is an abstraction that represents any one or more separate physical buses, point-to-point connections, or both, connected by appropriate bridges, adapters, or controllers. The interconnect 260, therefore, may include, for example, a system bus, in the form of a Peripheral Component Interconnect (PCI) bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called “Firewire”, and/or any other suitable form of physical connection.

The processor(s) 210 is/are the central processing unit (CPU) of the architecture 200 and, thus, configured to control the overall operation of the architecture 200. In certain embodiments, the processor(s) 210 accomplish this by executing software or firmware stored in memory 220. The processor(s) 210 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 220 is or includes the main memory of the architecture 200. The memory 220 represents any form of random access memory (RAM), read-only memory (ROM), flash memory, or the like, or a combination of such devices. In use, the memory 220 may contain, among other things, software or firmware code for use in implementing at least some of the embodiments introduced herein.

Also connected to the processor(s) 210 through the interconnect 260 is a communications interface 240, such as, but not limited to, a network adapter, one or more output device(s) 230 and one or more input device(s) 250. The network adapter 240 may be configured to provide the architecture 200 with the ability to communicate with remote devices over the network cloud 120 and may be, for example, an Ethernet adapter or Fibre Channel adapter. The input device 250 may include a touch screen, keyboard, and/or mouse, etc. The output device 230 may include a screen and/or speakers, etc. In an embodiment, the architecture 200 includes a receiving device (e.g., antenna) to receive satellite or other signals needed to calculate location.

The techniques introduced herein can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

The term “logic”, as used herein, means: a) special-purpose hardwired circuitry, such as one or more application-specific integrated circuits (ASICs), programmable logic devices (PLDs), field programmable gate arrays (FPGAs), or other similar device(s); b) programmable circuitry programmed with software and/or firmware, such as one or more programmed general-purpose microprocessors, digital signal processors (DSPs) and/or microcontrollers, or other similar device(s); or c) a combination of the forms mentioned in a) and b).

Note that any and all of the embodiments described above can be combined with each other, except to the extent that it may be stated otherwise above or to the extent that any such embodiments might be mutually exclusive in function and/or structure.

FIG. 3 is a block diagram showing contents of the mobile system 132 of FIG. 1. The mobile system 132 includes a global position system logic (GPS or position logic) 300, map data 310, a user interface logic (UI) 320, pin data 330, a recognition logic 340 and a transmission logic 350.

The GPS 300 includes any logic capable of determining position, such as a logic that uses satellite signals (GPS, Beidou, Glonass, Galileo, etc.), inertial navigation, and/or ground-based signals (LORAN-C). The map data 310 includes a database of graphical representations of terrain and/or topography as well as related data including names and addresses of terrain features (e.g., buildings, stores, monuments, etc.). In an embodiment, part or all of the map data 310 can be stored separate from the mobile system 132. For example, the map data 310 can be stored on the server 110 and accessed via the cloud 120.

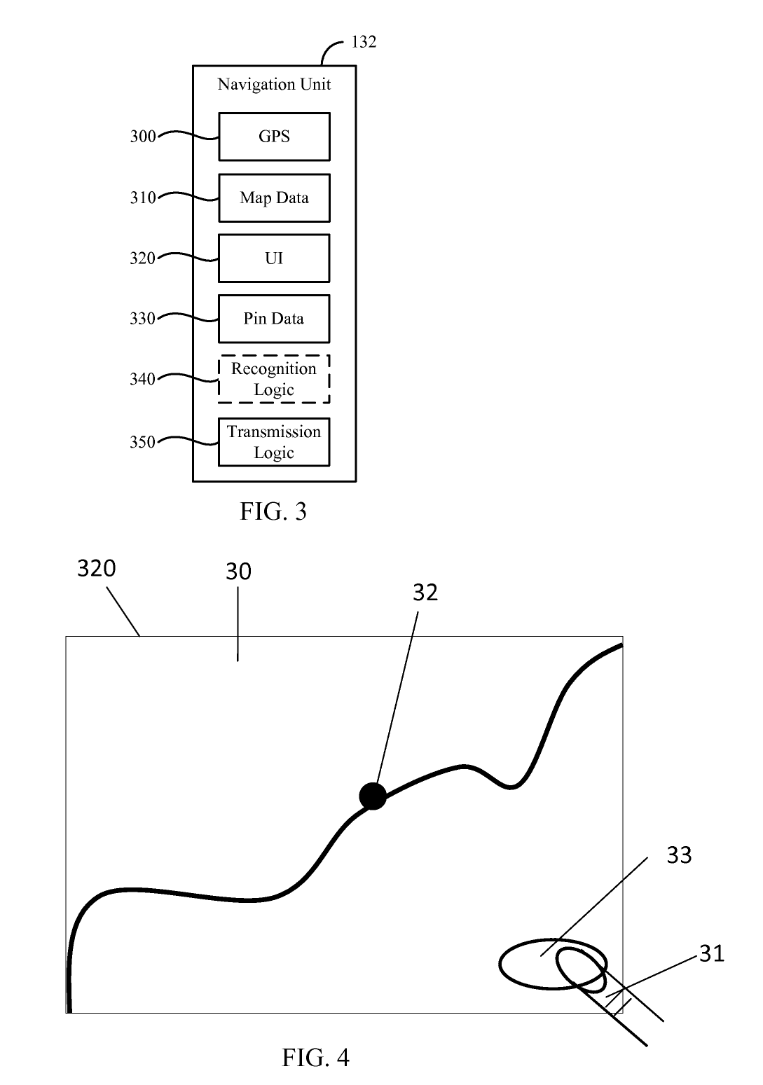

The UI 320, as will be discussed in further detail in conjunction with FIG. 4, displays the graphical representation on a screen of the mobile system 132 and enables a user to pin a location, e.g., by pressing a single button thereby generating the pin data 330. The pin data 330 includes coordinates of the current location or other location specified by a user on the screen and optionally, the above-mentioned related data for the coordinates.

The recognition logic 340, which is optional like other components, may be configured to determine a name of features using image recognition (e.g., pattern recognition) by comparing an image of a feature at the coordinates versus an image with a known name in the map data 310. The recognition logic 340 can obtain the feature image using a digital camera or other imaging device if so equipped and/or retrieve a street view from the map data 310 or other database (e.g., Google Street View). For example, when at coordinates of a McDonald's not listed in the map data 310, the recognition logic 340 obtains an image that includes golden arches and then compares the arches to images in the map data 310 that indicates golden arches represent the name McDonald's. In another example, the recognition logic 340 compares the obtained image of a building (e.g., McDonald's storefront) with another database of street images and associated data. If the recognition logic 340 determines a match, the associated data is then added to the pin data 330. The recognition logic 340 is not limited to comparing buildings, etc. but can be used for any other features, including natural features (mountains, etc.). In other words, the recognition logic 340 can determines names of features by comparing a specific characteristic of the features (e.g., logos) and/or larger views of the feature (e.g., an entire building).

In an embodiment, if the recognition logic 340 comes up with more than one match and/or has a low confidence for a match, the UI 320 can present results to a user for confirmation via a single input (e.g., single touch of the screen). Accordingly, the recognition logic has a technical effect of ensuring consistency and accuracy of the data. In another embodiment, the recognition logic 340 performs optical character recognition on the image to determine a name of the location.

The transmission logic 350 may be configured to interact with the UI 320 and the recognition logic 340 to transmit and receive data via the cloud 120 and/or a direct connection as needed.

FIG. 4 is an illustration of the UI 320 of the mobile system 132. In an embodiment, the UI 320 operates with a touch screen displaying a map 30 with a highlighted point 32 (e.g., current location of vehicle). A user can pin the location indicated by point 32 by tapping a digital button 33 with a finger 31. In other embodiments, the UI 320 can use voice recognition, gesture recognition, and/or any other input techniques.

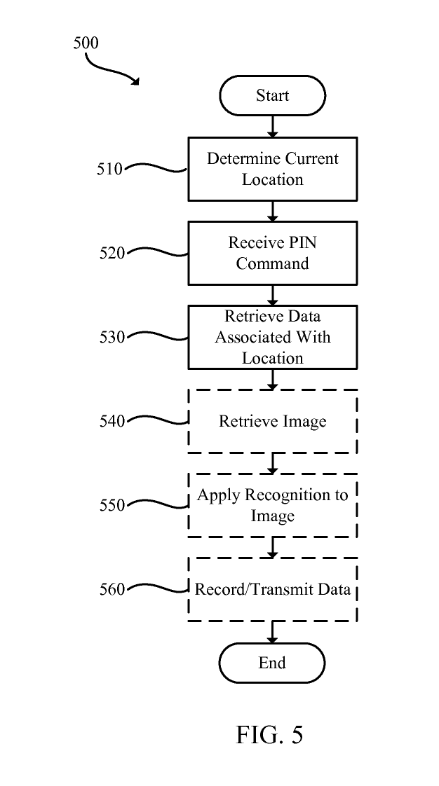

FIG. 5 is a flowchart illustrating a navigation marking technique 500. First, the GPS 300 determines (510) a current location and the UI 320 may optionally display and/or otherwise output (e.g., aurally) the location using the map data 310. The determining (510) can occur while a vehicle containing or a person carrying the GPS 300 is moving. A user then pins (marks) the location by inputting a pin command (e.g., by touching a pin button on screen, voice activation, etc.) which is received (520) by the UI 320. The UI 320 then retrieves (530) relevant data from the map data 310 corresponding with the coordinates, if available. In another embodiment, the UI 320, with the transmission logic 350, retrieves the relevant data from a remote source instead of or in addition to the map data 310.

In an embodiment, the recognition logic 340 also retrieves (540) an image as discussed above and applies (550) recognition algorithm(s) to the image. Optionally, the UI 320 can display results recognition algorithm(s) for a user to select. The transmission logic 350 then transmits data to the server 110 and/or computer 112, where the data can later be accessed, shared, etc. The transmission can be wired and/or wireless and the transmission logic 350 can buffer the data for later transmission if a network or a receiving device is unavailable. The method 500 then ends. In an embodiment, the user can also supply his/her own identifying information to the location and not rely on image matching technology. For example, location of a first date with spouse.

In an embodiment, a user retrieves the stored location data from the server 110 by logging in the dedicated website via the user's computer 112. The user can share the location data with his/her comments or recommendations to his/her friends through e.g. Email, Multimedia message or Social websites, etc.

Although embodiments have been described with reference to specific exemplary embodiments, it will be recognized that embodiments are not limited to the embodiments described, but can be practiced with modification and alteration within the spirit and scope of the appended claims. Accordingly, the specification and drawings are to be regarded in an illustrative sense rather than a restrictive sense.

1. A mobile system, comprising:
position logic configured to determine a position of the mobile system;
user interface logic configured to display the position determined by the position logic, retrieve data including a name associated with the position, and enable a user to mark the determined position; and
transmission logic configured to transmit the determined position and the retrieved data to a remote device in response to the user marking the determined position.

2. The system of claim 1, further comprising recognition logic configured to acquire an image corresponding with the determined position and match the acquired image against images with associated names in a database.

3. The system of claim 2, wherein the recognition logic is configured to acquire the image by searching the database for images at the determined position.

4. The system of claim 2, wherein the recognition logic is configured to use a subset of the acquired image for the matching.

5. The system of claim 2, wherein the recognition logic is configured to perform optical character recognition on the acquired image to determine a name of the position.

6. The system of claim 1, wherein the user interface logic is configured to retrieve the data in response to a user command including a touch on a touch screen.

7. The system of claim 1, wherein the user interface logic is configured to retrieve the data from a remote server using the transmission logic.

8. The system of claim 1, wherein the remote device is configured to store the determined position and the retrieved data for later access by the user.

9-17. (canceled)

18. The system of claim 1, wherein the user interface logic is further configured to enable the user to mark the determined position in response to only a single input.

19. The system of claim 18, wherein the single input is a single button press.

20. A mobile system, comprising:
means for determining a position of the mobile system;
means for displaying the position of the mobile system and retrieving data including a name associated with the position;
means for enabling a user to mark the determined position; and
means for transmitting the determined position and the retrieved data to a remote device in response to the user marking the determined position.

21. A method, comprising:
determining, with position logic, a position of a mobile system in which the position logic is located;
displaying, with user interface logic, the position determined by the position logic;
retrieving, with user interface logic, data including a name associated with the position;
enabling, with the user interface logic, the user to mark the determined position; and
transmitting, with a transmission logic, the determined position and the retrieved data to a remote device in response to the user marking the determined position.

22. The method of claim 21, further comprising:
acquiring, with recognition logic, an image corresponding with the determined position; and
matching, with the recognition logic, the acquired image against images with associated names in a database.

23. The method of claim 22, wherein acquiring, with the recognition logic, the image corresponding with the determined position comprises acquiring the image by searching the database for images at the determined position.

24. The method of claim 22, wherein matching, with the recognition logic, the acquired image against images with associated names in the database comprises using a subset of the acquired image for the matching.

25. The method of claim 22, further comprising performing, with the recognition logic, optical character recognition on the acquired image to determine a name of the position.

26. The method of claim 21, wherein retrieving, with the user interface logic, data further comprises retrieving the data in response to a user command including a touch on a touch screen.

27. The method of claim 21, wherein retrieving, with the user interface logic, data comprises retrieving the data from a remote server with the transmission logic.

28. The method of claim 21, further comprising storing, at the remote device, the determined position and the retrieved data for later access by the user.

29. The method of claim 21, wherein enabling, with the user interface logic, the user to mark the determined position comprises enabling the user to mark the determined position in response to only a single input.
